(19) United States
(12) Patent Application Publication
(10) Pub. No.: US 2015/0006194 A1
(43) Pub. Date: Jan. 1, 2015

(54) INTERACTIVE CIRCUIT BASED ON THE USE OF DEVICES WITH TOUCH SCREEN TECHNOLOGY

(71) Applicant: Carlalberto STEFANI, (US)

(72) Inventor: Carlalberto Stefani, Lucca (IT)

(21) Appl. No.: 14/378,769

(22) PCT Filed: Feb. 12, 2013
(86) PCT No.: PCT/IT2013/000045

§ 371 Date: Aug. 14, 2014

(30) Foreign Application Priority Data
Feb. 15, 2012 (IT) LU2012A000003

(51) Int. Cl. G06Q 30/06; G06F 19/00; G06Q 20/20

(52) U.S. Cl. CPC G06Q 30/0641; G06Q 20/204; G06F 19/328
USPC 705/2; 705/27.1; 705/17

(57) ABSTRACT

Interactive circuit based use of devices with touch screen technology, includes: a server connected to the Internet; a web portal resident in the server together with respective databases; personal identification cards on which the card owners' identification data are stored; a plurality of interactive cores, each including: at least one touch screen device provided with at least one surface clickable at the touch of a finger and at least one screen having at least one section dedicated to the portal resident; at least one local computer for managing the screen and data displayed thereon; at least one device for reading personal identification cards; an Internet access point; wherein the interactive cores, the profiles/sites and any websites are interconnected and interact via the portal resident, to create a professional circuit, which can be controlled centrally, between subjects who belong to the circuit and are each provided with the interactive cores.

The invention relates to the field of electronic devices suitable for the display and sale of goods and services or for the management of commercial and financial business.

In particular, the invention relates to an interactive circuit substantially based on the use of touch screen devices and of computers connected in a network, so as to create, for each sector to which the touch screen technology can be applied, a commercial professional circuit of interconnected stores or private or public activities, both on national and on international scale. Circuits belonging to the same sector, in different States, can be in turn interconnected, in order to create for each sector a single global circuit.

Touch screen device is intended as an electronic equipment provided, in the majority of cases, with its own frame, which provides or uses a surface of its own or another surface (having the function of screen) clickable, and therefore interactive, at the touch of a finger, by means, currently, of a holographic film or the like. For example, current examples of touch screen devices are interactive displays (solution with monitor, with overhead projector, with holographic cube, or other similar devices), indoor and outdoor totems, interactive tables, wall or table screens.

In more detail, the interactive display window is applied to the inner face of the display window of premises and therefore facing outwards; the totem is a column structure, with integrated monitor, which can be positioned in any space, both indoor and outdoor; the interactive table is a table with integrated monitor.

Each of said devices is normally managed by a dedicated computer, which can be integrated, or not, in its own supporting structure, which in the majority of cases contains the data to be consulted by the user.

Just like other touch screen devices, currently the interactive display window substantially operates above all in a isolated manner, by offering users who consult it access only to its own local contents (on rare occasions also to a few selected web pages), or only to contents linked to the proposals of the activity (or of the public structure) in which it is housed. At times, in place of dedicated software, the user consulting the display is offered direct access to its website, also with links to some preselected web pages. Only some software packages (dedicated to specific sectors) enable users to send a format in order to be contacted with answers to their requests.

Nonetheless, it is not currently possible to register with and log in to circuits that group together all the activities, from the same sector, belonging to them; i.e. there is no interaction between the user and the display windows (or other touch screen devices or mixed solutions) of all the activities belonging to a circuit, via a server/portal that places and keeps them in constant communication.

Circuits of the kind forming the subject matter of the present invention will be destined to create a new type or market, based on sharing, cooperation, transparency, reliability and professionalism.

In virtue of the aforesaid considerations, it is understood that, in this historical context of global crisis, the high costs of display windows (as well as of any other touch screen devices) are not currently justified by the limited services they offer users and by the practically inexistent gains they generate for those who own and/or manage them.

The present invention aims to transform touch screen devices, from means that so to speak “embellish” and give a modern touch to the structure in which they are housed (nevertheless offering limited usefulness and imperceptible economic returns) into new and sophisticated commercial tools.

Moreover, while the web is swarming with pages and outdated notices and scams, often making reliable content difficult to find, the present invention will offer its users, sector by sector, a professional reference point, a sort of web accessible from the road, safe and constantly updated by its members and its managers.

The object of the present invention is to provide an interactive electronic tool that enables the user, following identification, not only to view the products, services or business proposed to the client locally, but also to generate commercial opportunities, expanding the store's range of action, through interactive management of commercial information between stores interconnected in a network.

A further object is, in particular, to create a professional circuit for sectors related to the sale of products or services, or for the management of non-commercial activities, such as apartment building management networks, to which touch screen technology can be applied.

Another object is that of making touch screen technology, which currently has still not achieved the success it deserves, easy to sell.

Yet another object of the invention is that of interconnecting in a network companies provided with an interactive display window (or other touch screen device) or stores of a same company or a same commercial network, via an on-line portal containing the respective profiles-sites, optionally also connected to the respective autonomous websites of the companies connected.

Further object of the invention is that of creating a global circuit, for each sector in which it is applied.

It must be underlined that, with the appropriate modifications known to those skilled in the art, the interactive display window, destined to face the outside of the premises in which it is housed, can be replaced by another touch screen device, such as an indoor totem, a wall or table screen, an interactive table, in the case in which it is to be used in an indoor space, or by an outdoor totem, in the case in which it is to be installed in an outdoor space.

These objects are achieved by an interactive circuit based on the use of devices with touch screen technology, comprising:
a server connected to the Internet;
a web portal resident in said server together with the respective databases, wherein said portal is suitable for:
   containing and proposing notices and products in an anonymous form, so that no-one can directly contact the person who entered them in said circuit;
   containing profiles/sites of the circuit members;
   coordinating with the existing websites of the circuit members' activities and with interactive cores;
a plurality of interactive cores, each comprising:
   at least one device of touch screen type, provided with at least one surface clickable at the touch of a finger and at least one screen (or other device having the same function) having at least one section dedicated to said portal resident in said server;
   at least one local computer suitable for managing said screen and the data displayed thereon;
   at least one reading device for reading personal identification cards;
   an Internet access point;
personal identification cards on which the card owners' identification data are stored,
   wherein said interactive cores, the profiles/sites and any websites are interconnected and interact via said portal resident in said server, so as to create a professional circuit, which can be controlled centrally, between subjects who belong to the circuit and who are each provided with said interactive cores.

The interactive core can comprise one or more screens, or similar devices, dedicated to digital signage.

Advantageously, the device for reading personal identification cards is connected to the local computer by means of a connection, preferably wireless, for the interactive display windows or directly, by cable, for the other touch screen devices, and is located in a point accessible to the user who wishes to consult the information available in the interactive core being used.

According to a possible embodiment of the invention, said personal identification card is a health insurance card provided with microchip.

According to a further embodiment of the invention, said card is a card provided with magnetic band and/or microchip issued by the professional circuit manager via an operator provided with the interactive core.

According to a further alternative embodiment, said card comprises a QR type two-dimensional barcode containing the data of the card owner. In this case, the reading device will be of the type with infrared rays.

According to some preferred features of the invention, said interactive core also comprises at least one proximity sensor, at least one acoustic warning signal, at least one warning light, at least one camera and at least one payment card reader (if considered necessary).

According to a further feature of the invention, the screen (or other device used having the same function) of the touch screen device comprises a clickable area divided into at least two distinct portions, the one suitable for displaying images and information resident in the local computer, the other for displaying the contents of the web portal (if necessary extrapolated) that makes use of said server.

The invention presents numerous advantages.

Due to the connection of the interactive cores in a network it is possible to create circuits containing “items” that in a certain way are guaranteed by the person entering them in the circuit, i.e. it is always possible to trace a responsible person as he/she belongs to a company that is real and physically exists. Moreover, the client who makes use of this interactive core to start a transaction, can refer to, and therefore receive the due assistance during the purchase, the company housing the touch screen device on which the product of interest was displayed, which in turn can refer to the company that entered it into the circuit, as its own. Companies that wish to belong to said circuits must naturally have specific requirements.

All this takes place with maximum transparency and professionalism and offers new earning opportunities to those belonging to the circuit, as, with sharing, they can expand the range of action of their commerce and counteract the contractions to which markets have been subjected in recent years. Advantageously, each trader belonging to the circuit can participate in the transactions of items proposed by others (as well as of its own items in the aforesaid dedicated section) in the area/s of the screen/s (or other devices having the same function) of its interactive core dedicated to the portal, in which products are offered that would otherwise never have been handled, being outside his/her territory.

Due to the use of the reading device for reading personal cards containing the card owner identification data:
the work of the user of the interactive core decreases and, indirectly, also that of the trader, who no longer requires to have a hand in registering the user from his/her personal computer;
the user of the interactive core is recognised upon inserting the personal card;
logout is linked to removal of the card;
the personal card prevents the trader from sending false requests to himself/herself via his/her own interactive core, for the purpose of accumulating contacts and thus receiving any bonuses or discounts from the manager of the circuit who wishes to reward the ability to generate business;
it prevents the ill-intentioned from sending false requests and playing pranks;
the portal is always provided with the identification data of users, which are automatically stored in the user database, providing extremely useful archives;
each access can be controlled and provides the portal with data regarding who has logged in, from which interactive core and when;
statistics and evaluations can be performed using the data stored in the databases of the server (i.e. obtain samples of age brackets and gender of those who access the interactive core most frequently);
it ensures the utmost transparency and professionalism.

Some examples of professional circuits that can be created due to the use of the system comprising the interactive cores, each with its own features, are:
real estate circuit (dealing with sales, rentals, investments, advertising campaigns, etc.);
motor vehicle circuits, between car dealers (sales, rentals, etc.);
circuit for the management of apartment buildings and property in general;
circuit for travel agencies and between travel agencies and structures linked thereto;
circuit between hotel structures, and between hotel structures and structures linked to them.
health care circuits;
company circuits (between stores and headquarters of the same companies).

The operation and advantages of the invention will be more apparent below, in the description of preferred embodiments, provided by way of non-limiting example, and with the aid of the figures wherein:

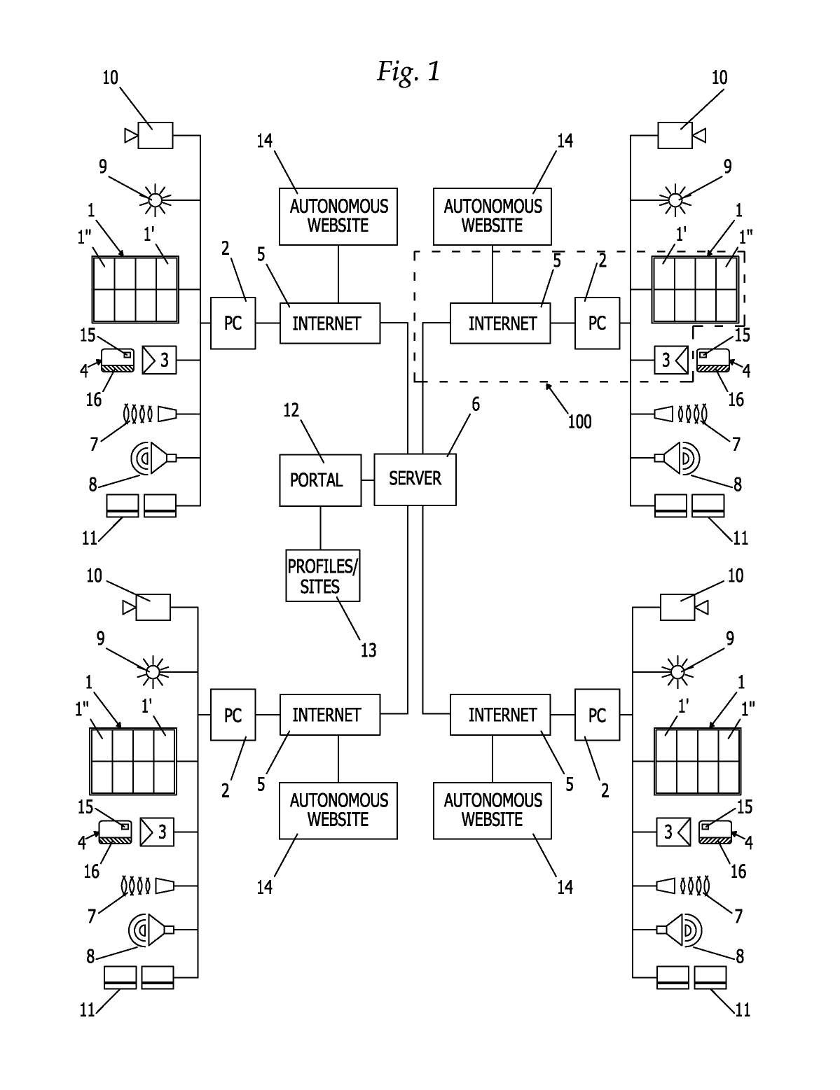

FIG. 1 represents a basic diagram of an interactive circuit based on the use of devices with touch screen technology according to the invention;

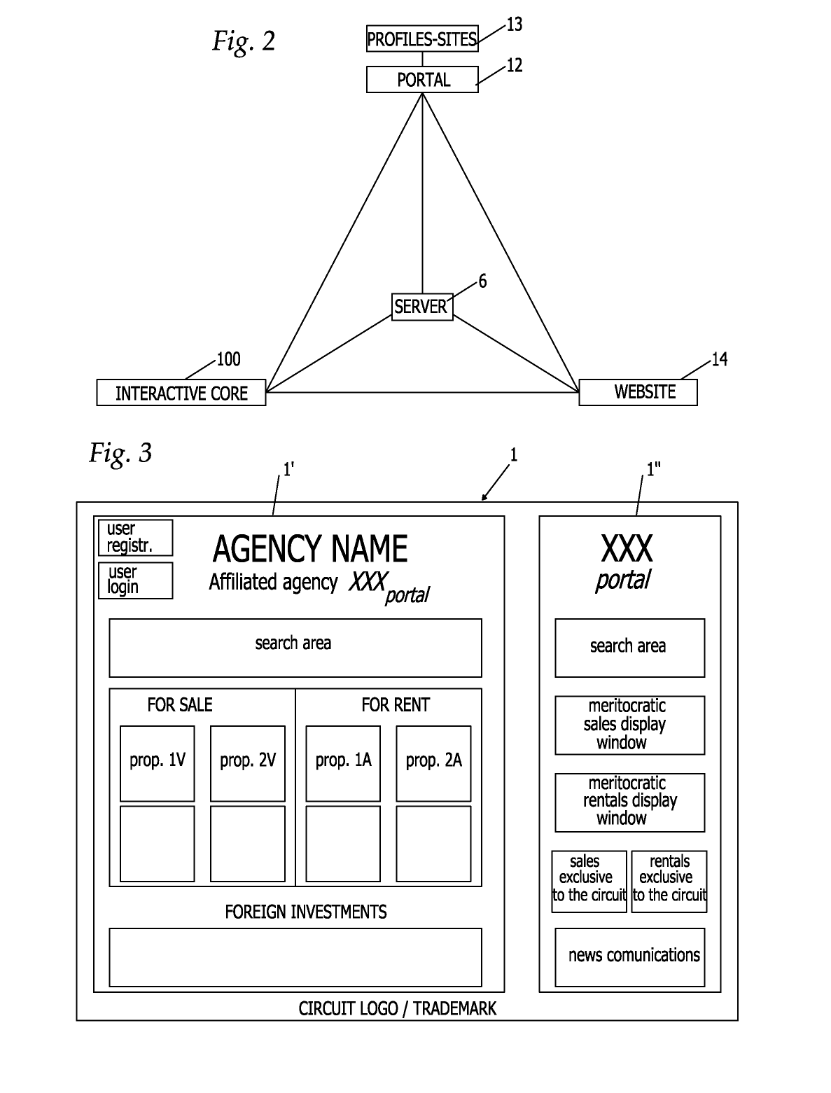

FIG. 2 represents a diagram of communication between the main components of the interactive circuit;

FIG. 3 represents a screen of a touch screen device, with a division used, for example, in real estate, motor vehicle and travel agency circuits, in the case in which the solution with a single monitor and a single computer is selected;

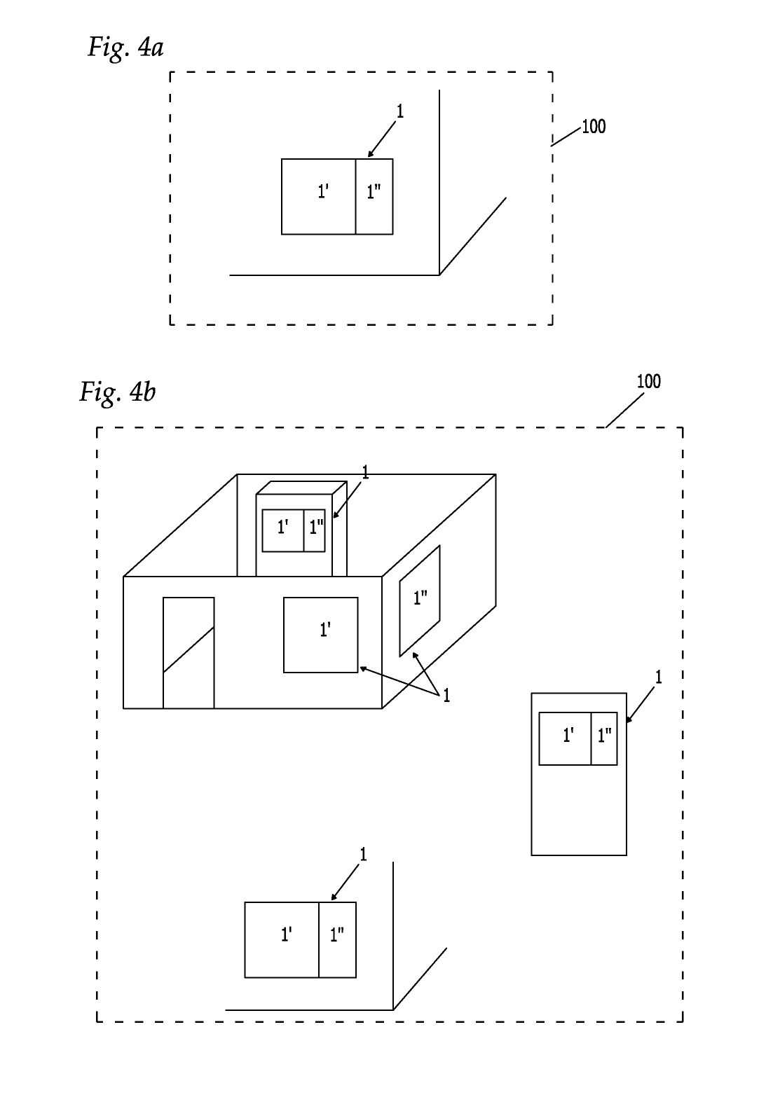

FIGS. 4a and 4b represent some examples of interactive core, simple and complex;

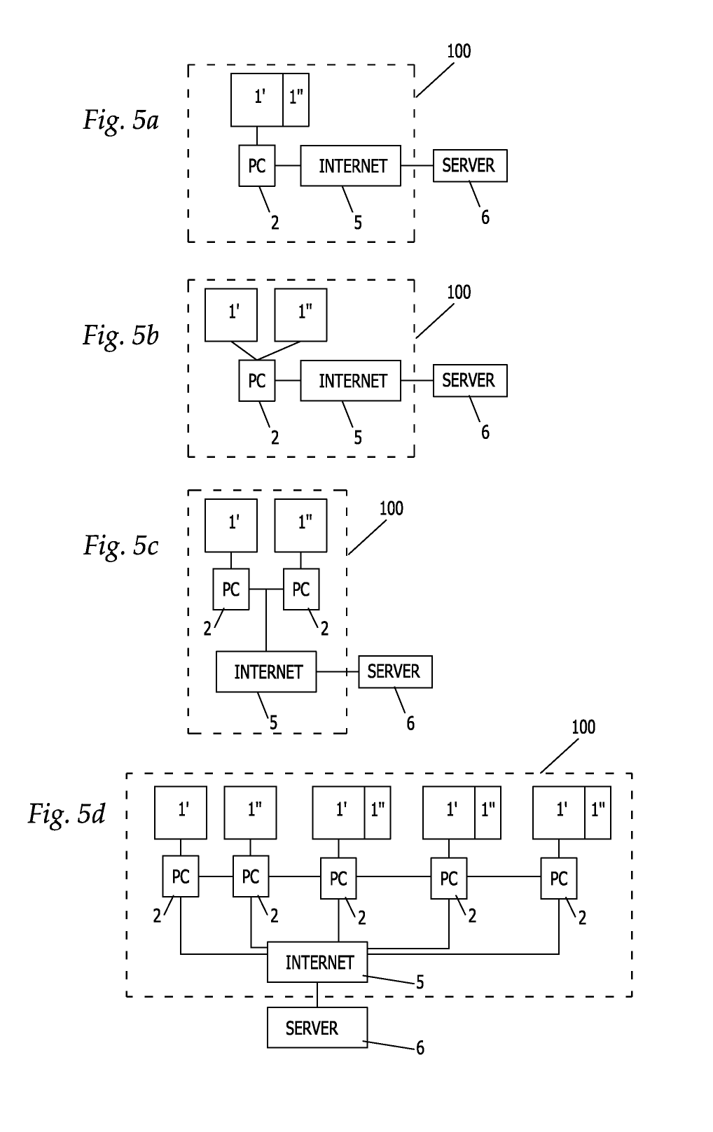

FIGS. 5a-5d represent some cases of connection and management of the touch screen devices via local computer/s;

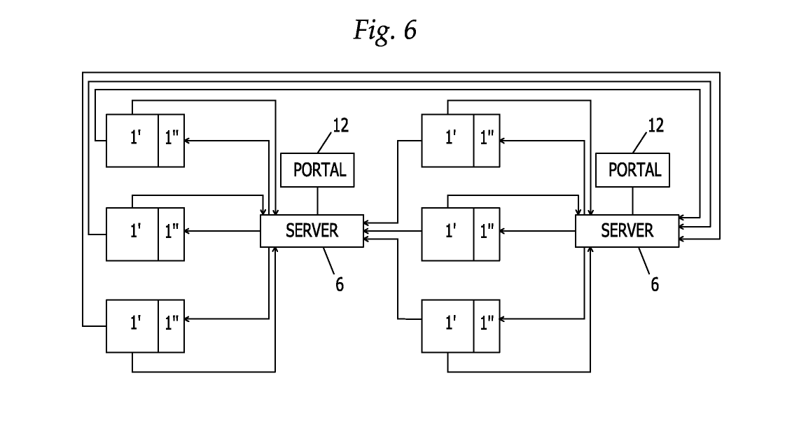

FIG. 6 represents a basic operating diagram of a global circuit and connection between the circuits of a same sector belonging to different world states.

With reference to FIG. 1, the interactive circuit based on the use of devices with touch screen technology comprises a server 6 in which a web portal 12 is resident.

The web portal 12 is resident in said server together with the respective databases, and is suitable for:
containing and proposing notices and products in an anonymous form, so that no-one can directly contact the person who entered them in the circuit;
containing profiles/sites of the circuit members, where profile/site is intended as a profile, related to each activity belonging to the circuit, created within the portal, and which generally proposes the same contents as the activity's website;
coordinating with the existing websites of the circuit member activities and with interactive cores 100.

The server 6 is in fact connected via the Internet to a plurality of interactive cores 100.

Each interactive core 100 comprises:
at least one touch screen device 1 provided with at least one surface clickable at the touch of a finger and at least one screen (or other device having the same function) having at least one section dedicated to said portal 12 resident in said server 6;
at least one local computer 2 suitable for managing said screen (or other device having the same function) and for managing and storing the data that appear thereon relating to the offers-notices of the member who owns the interactive core 100;
at least one reading device 3 for reading personal identification cards 4 and preferable one for each touch screen device 1;
an internet access point 5, suitable for connecting the local computer/s 2 with the server 6.

The use of the interactive core 100 by the user requires the use of personal identification cards 4 on which the card owner identification data are stored,

The interactive core can comprise one or more screens, or similar devices, dedicated to digital signage.

The screen/s dedicated to digital signage will be controlled by local PCs and the contents managed by the portal or by the owner of the interactive core.

A screen can be substituted by any device having the same function.

Further components of the interactive core 100, preferably present in the same number as the touch screen devices 1, are:
at least one proximity sensor 7;
at least one acoustic warning signal 8;
at least one warning light 9;
at least one camera 10;
at least one payment card reader 11.

In the case in which the interactive core is formed by a single touch screen device and therefore by only one monitor (or other device having the same function) the local computer 2 is connected in a network via the internet (or intranet) access point 5, so as to be connected to the portal 12 resident in said server 6, containing the profiles/sites 13 of the operators who own the interactive cores (e.g. interactive display windows) and to any autonomous website 14 of said operator.

Operation is the same when more than one local computer is connected to a touch screen device of the interactive core. Moreover, one local computer could manage several touch screen devices simultaneously, although abundance of computers ensures greater reliability.

The personal card 4 reader 3 is connected to the local computer 2 via a connection, preferably wireless, for the interactive display windows or directly, by cable, for the other touch screen devices, and is located in a point accessible to the user wishing to consult the information available in the interactive core being used.

According to equivalent embodiments of the invention, the personal cards 4 are of the type provided with a microchip 15 and/or a magnetic band 16 suitable for containing, stored, the card holder's personal data.

Said types of cards are, for example, health insurance cards, but alternatively can also be electronic identity cards or other cards issued specifically by the professional circuit manager and supplied to the client by the operator provided with the interactive core.

The proximity sensor 7 is of the type suitable for detecting the presence of a user who is consulting the screen of the interactive core and is connected to said local computer 2 so that this latter can activate said acoustic warning signal 8 and said warning light 9 if the user moves away from the screen without removing the personal card 4 from the reader 3.

The camera 10 will be of the type suitable for surveillance of the access area to the touch screen device and, in an embodiment of the invention not shown, the camera 10 can be connected to an anti-theft system present in the place of installation.

In an embodiment of the invention catering for the need to make

payments directly in the site in which the interactive core is located, a payment card reader 11 can be provided.

With reference to FIG. 2, the diagram of communication between the components of the interactive system shows how the server 6 is the anchor point for the portal 12 and the profiles/sites 13, the autonomous website 14 and the interactive cores 100, with which it communicates constantly. It can be seen from the diagram that, by updating one or more databases from one of its component, all the other databases are automatically updated. This will be made possible by a specific operating software.

With reference to FIG. 3, representing the solution of the interactive core with a single touch screen device and a single monitor (or other device having the same function), the screen of said touch screen device 1 is (in some circuits such as the real estate, motor vehicle and travel agency circuits) divided into at least two distinct portions 1′ and 1″.

The area 1′ will be dedicated to images and information resident in the local computer 2, while the area 1″ will be reserved for the portal 12 (resident in the server 6) and for its contents.

A portion of the area 1′ can propose contents all the same managed by the portal (in the case of real estate agencies, these will, for example, be the offers relating to foreign property investments).

A touch screen device with screen (or device having the same function) divided into two areas 1′ and 1″ can be substituted by 2 touch screen devices (side by side or not) and managed by a same local computer, or by different local computers.

With reference to FIG. 4a, there is shown an interactive display window provided with a single screen (or device having the same function) divided into two areas 1′ and 1″. Alternatively, as shown in FIG. 4b, said interactive core can have two or more touch screen devices 1. For example, in the case of two touch screen devices 1, this will be constituted by (at least) two screens side by side or superimposed or positioned at a variable distance, in one of which the same area 1′ is present and in the other the same area 1″ is present.

FIG. 4b provides an example of how the two areas 1′ and 1″ can be proposed simultaneously on a plurality of touch screen units of a same interactive core.

With reference to FIGS. 5a-5d, the touch screen devices can be managed by one or more local computers 2. If several devices are managed by a same local computer, a software must be designed or used that is capable of managing two surfaces of touch screen type independently, and therefore a plurality of simultaneous touches on different surfaces.

Other monitors (or surrogate devices), having digital signage or interactive functions, can be used and managed by the local computer/s 2.

The touch screen device/s is/are managed by the local computer/s 2. The contents of the same touch screen device or of different devices are managed by the interactive core owner and by the portal manager, respectively via the local computers and the server.

Ultimately, the operating principle will be the same both in the case in which the interactive core is formed by a single touch screen device and by a plurality of units.

In any case, coexistence of the areas 1′ and 1″ in close proximity to each other, i.e., respectively, of the specific contents (items, business proposals, etc.) of the premises in which the interactive core is housed and of the portal of that circuit, will be fundamental.

By way of example and with reference to FIG. 4b, there is proposed below, a configuration of complex interactive core, formed by the following units:
interactive display window on a display window of the premises containing the section 1′;
interactive display window on another display window of the premises containing the section 1″;
indoor totem containing the section l′ and the section 1″;
outdoor totem located in a square or in a nearby or distant shopping mall containing the same areas 1′ and 1″.

Further configurations can be obtained by implementing the system with further touch screen devices 1.

It can be understood that, in each interactive circuit, all the touch screen devices and the respective local computers of the interactive core will always be synchronised with one another and with the other interactive cores of the same circuit.

FIG. 6 represents the base operating diagram of a global circuit, and therefore the connection between circuits of a same sector, belonging to different world states that will adopt the interactive circuit according to the present invention. In practice, in each state adopting the circuit, the portal 12, resident in the respective server 6, will contain and propose, in the areas 1″ of each interactive core, the notices of members within the state it manages and those from circuit members of the same sector of other states. The servers of all the states will therefore be in communication and synchronized at all times. By way of example, communication of the circuits of a same sector belonging to two states is depicted; in particular, how a portal (and therefore the server) of one state collects the notices regarding products of the circuit members of all other states displayed in the areas 1′, proposing them in the areas 1″ of the interactive cores of the state it manages. The same thing occurs respectively for the portals of the other states.

The graphic interface will preferably be the same for all the sites-profiles, for the websites and for the screens of the interactive cores, with the exception of a few customisations, for example, as occurs on Facebook, in order to make consultation extremely simple for any user, even those with little experience. Coherently, these environments will (preferably) have interfaces very similar to one another, if possible identical (as must occur between profile/site, area 1′ of the interactive core, website).

Operation of the interactive circuit based on the use of devices with touch screen technology according to the invention is described below, considering in this case the basic interactive core, i.e. of the simplest form, that is, composed of only one touch screen device and of one local computer, besides the other peripherals already present.

The owner of the premises that house the interactive core 100 can enter his/her own commercial notices from the local computer 2 or from a remote computer, connected in a network with that of his/her interactive core. These are stored on the hard disk of the computer dedicated to the specific interactive core. A software will update the notice/store database present on the server 6 which, consequently, will update the profile/site 13, the website 14 and the portal 12.

The owner can also update his/her notices from the website, or from the profile/site according to the “centred triad” diagram of FIG. 2.

Both on the interface of the interactive core, and on the web-interface application that manages the website and the profile/site, there will be control buttons that enable the owner to enter notices and customise his/her area, according to the prior art.

The user who does not wish to request information, but instead only wants to consult the offers of products for sale, can do so freely without having to register, or log in if already registered. By clicking on an item, it will preferably open full screen.

The user can register in the interactive circuit as soon as he/she find a product of interest regarding which he/she wishes to receive information. Clicking will open a window inviting him/her to register.

He/she will be asked to insert the personal identification card 4 into the specific external peripheral 3, positioned in proximity of the screen of the touch screen device. This procedure will enable identification of the client by extracting some of his/her data from the microchip 15 of the card 4. Finally, he/she must key in (using a virtual keyboard of touch screen type) any data requested or missing, such as: telephone number, address, email. If considered necessary, he/she must complete the registration process by entering an access password or fingerprint, or using vocal, facial or ocular recognition, or another recognition system used as password that a software on the computer 2 of the interactive core is able to catalogue and decode during subsequent accesses.

After registration has been completed, the user's data will be automatically stored in the databases of the server dedicated to registration and his/her initial login will take place automatically.

Logout will take place when the card 4 is removed from the peripheral 3.

In fact, the card 4 must remain in the reader 3 at all times during consultation or requests.

Registration can also take place from the profile-site 13, from the portal 12 or from the website 14. After registration, the user will be automatically logged in.

If a user registered in the circuit via the website 14 or the profile-site 13, he/she will be asked to enter the card 4 during the first access to the interactive core. Then, if recognised, the user will confirm his/her data as above, or modify any data that have changed (i.e. address, mobile phone number, etc.) otherwise, the user must register again. At each subsequent access the user will be asked to confirm data (such as address, mobile phone number, email, etc.), i.e. those likely to change in time. Naturally, if the user is not recognised, he/she must register.

The reader 3 is a peripheral that, as mentioned above, is installed in proximity of the screen of the interactive core, (for example: on the door frame, directly on the glass of the display window, on a nearby door, integrated in the body of the totem, of the wall or table screen, of the interactive table, etc). The reader 3 is a peripheral into which the card 4 can be inserted, and which, in the case of interactive display windows, is preferably of Bluetooth or wireless type.

Once the user has found an item of interest, in the section dedicated to the portal (and therefore without knowing which company entered it in the circuit), he/she must fill in a format to request information, which will be sent automatically via email (by the software of the interactive core 100) both to the trader housing the interactive core 100 and to the portal 12, hosted by the server 6, and, optionally, a copy can be sent to the email address of the same user as a reminder. The client will thus be contacted by the trader, who may be a simple business finder (who receives a fee deemed appropriate for each client found), or, at his/her discretion and advantage, can take an active part in the brokerage stage.

Naturally, if the user is interested in an item proposed by the owner of the interactive core in the area 1′ dedicated to his/her products, he/she can contact the owner directly, in any case preferably by sending the format.

The same occurs if a user is interested in a product proposed in the portal of his/her state, by a member of a foreign circuit (of the same sector) through the connection represented in FIG. 6. Therefore, contact personnel (including interpreters) will exist in each state, to enable the user of one state to contact, via the manager of the interactive core on which he/she viewed the item of interest or via the manager of the portal of his/her own state, the member of the foreign state that entered the notice of the product of interest in the circuit.

As already mentioned, the names of companies will be hidden in the area 1″ (relating to the portal) of the interactive core and in the Internet portal. The client will only be able to find out these names, each time, through the intercession of the subject who manages the portal or of the trader who owns the interactive core, who will place him/her in contact with the subject who entered the notice in the circuit.

At the same time, the data relating to that contact, generated by the area of the interactive core, will reach the portal 12. All relevant data will be automatically entered in specific databases of the portal 12 in the server 6, through a web application of the same portal, according to the prior art.

As already mentioned, all the contents of the registration forms (users, traders owning and/or managing the interactive cores, managers of the interactive cores) and of the formats coming from the various stations (interactive cores, profiles-sites, websites, portal) will be extrapolated and stored, by means of dedicated software, in the databases of the server 6.

The invention has been described with reference to touch screen devices, but naturally, in addition to touch screen devices, and therefore to their clickable surfaces, it is also possible to use devices that generate holograms (or similar), and the user can virtually touch the points (having precise coordinates) by moving his/her hands in space.

In the same way, other electronic devices can also be connected to the circuits, such as smartphones, tablets and all those devices compatible with the circuits and their logic, for which special software applications will optionally be designed.

1. Interactive circuit based on the use of devices with touch screen technology, comprising:
a server (6) connected to the Internet;
a web portal (12) resident in said server (6) together with the respective databases, wherein said portal is suitable for:
containing and proposing notices and products in an anonymous form, so that no-one can directly contact the person who entered them in said circuit;
containing profiles/sites of the circuit members;
coordinating with the existing websites of the circuit members' activities and with interactive cores (100);
a plurality of interactive cores (100), each comprising:
at least one device of touch screen type (1) provided with at least one surface clickable at the touch of a finger and at least one screen having at least one section (1″) dedicated to said portal (12) resident in said server (6);
at least one local computer (2) suitable for managing said screen and the data displayed thereon;
at least one reading device (3) for reading personal identification cards (4);
an Internet access point (5);
personal identification cards (4) on which the card owners' identification data are stored,
wherein said interactive cores (100), the profiles/sites and any websites are interconnected and interact via said portal (12) resident in said server (6), so as to create a professional circuit, which can be controlled centrally, between subjects who belong to the circuit and who are each provided with said interactive cores (100).

2. Interactive circuit as claimed in claim 1, characterized in that said interactive core (100) comprises one or more devices dedicated to digital signage.

3. Interactive circuit as claimed in claim 1, characterized in that said personal identification card (4) is a health insurance card provided with microchip (15).

4. Interactive circuit as claimed in claim 1, characterized in that said personal identification card (4) is a card provided with magnetic band (16) and/or microchip (15) issued by the professional circuit manager via an operator provided with the interactive core (100).

5. Interactive circuit as claimed in claim 1, characterized in that said personal identification card (4) comprises a QR type two-dimensional barcode.

6. Interactive circuit as claimed in claim 1, characterized in that said interactive core (100) comprises at least one proximity sensor (7).

7. Interactive circuit as claimed in claim 1, characterized in that said interactive core (100) comprises at least one acoustic warning signal (8) and/or at least one warning light (9).

8. Interactive circuit as claimed in claim 1, characterized in that said interactive core (100) comprises a camera (10).

9. Interactive circuit as claimed in claim 1, characterized in that said interactive core (100) comprises at least one payment card reader (11).

10. Interactive circuit as claimed in claim 1, characterized in that the screen of the touch screen device (1) comprises a clickable area divided into at least two distinct portions (1′, 1″) suitable respectively for displaying images and information resident in the local computer (2) and in the portal (12).
